(19) United States
(12) Patent Application Publication
(10) Pub. No.: US 2019/0184656 A1
(43) Pub. Date: Jun. 20, 2019

(54) STRIP LAMINATION METHOD AND APPARATUS

(71) Applicant: The Goodyear Tire & Rubber Company, Akron, OH (US)

(72) Inventor: James Alfred BENZING, II, North Canton, OH (US)

(21) Appl. No.: 15/846,832

(22) Filed: Dec. 19, 2017

(51) Int. Cl. B29D 30/00; B29D 30/30

(52) U.S. Cl. CPC B29D 30/0005; B29K 2021/00; B29D 30/30

(57) ABSTRACT

According to one aspect of the invention, an apparatus for forming a strip of rubber is described. The apparatus comprises a support frame; a first and second roller mounted on the support frame, wherein the first and second rollers are spaced apart from each other; and an application roller located adjacent a head, and a channel formed between the head and the outer surface of the application roller and the inner surface of the head; wherein said channel has an inlet and an outlet, wherein the inlet is located near the second roller, and the outlet is located adjacent a die. A method of forming a rubber strip is also described which includes the steps of providing a support frame with a first and second roller mounted thereon, wherein the first and second rollers are spaced apart from each other; threading a rubber stock about the first and second roller, and then through a channel formed between a head and a rotating application roller, and then through an outlet die.

### FIELD OF THE INVENTION

The invention relates generally to rubber processing, and more particularly to a method and apparatus for making a strip of rubber.

### BACKGROUND OF THE INVENTION

The invention describes a method and apparatus necessary to make a strip of rubber material useful for tire building. Typical prior art methods of making a rubberized strip generally utilize expensive equipment such as gear pumps and extruders. Extruders are typically very high pressure and require large amounts of horsepower in order to form a small strip. Extruders are expensive, and if not used properly, may overheat or overwork the rubber. Thus, an apparatus and method of efficiently producing a rubber strip is desired.

### SUMMARY OF THE INVENTION

According to one aspect of the invention, an apparatus for forming a strip of rubber is described. The apparatus comprises a support frame; a first and second roller mounted on the support frame, wherein the first and second rollers are spaced apart from each other; and an application roller located adjacent a head, and a channel formed between the head and the outer surface of the application roller and the inner surface of the head; wherein said channel has an inlet and an outlet, wherein the inlet is located near the second roller, and the outlet is located adjacent a die.

A method of forming a rubber strip comprising the steps of providing a support frame with a first and second roller mounted thereon, wherein the first and second rollers are spaced apart from each other; threading a rubber stock about the first and second roller, and then through a channel formed between a head and a rotating application roller, and then through an outlet die.

### Definitions

“Aspect ratio” of the tire means the ratio of its section height (SH) to its section width (SW) multiplied by 100 percent for expression as a percentage.

“Asymmetric tread” means a tread that has a tread pattern not symmetrical about the center plane or equatorial plane EP of the tire.

“Axial” and “axially” means lines or directions that are parallel to the axis of rotation of the tire.

“Chafer” is a narrow strip of material placed around the outside of a tire bead to protect the cord plies from wearing and cutting against the rim and distribute the flexing above the rim.

“Circumferential” means lines or directions extending along the perimeter of the surface of the annular tread perpendicular to the axial direction.

“Equatorial Centerplane (CP)” means the plane perpendicular to the tire's axis of rotation and passing through the center of the tread.

“Footprint” means the contact patch or area of contact created by the tire tread with a flat surface as the tire rotates or rolls.

“Inboard side” means the side of the tire nearest the vehicle when the tire is mounted on a wheel and the wheel is mounted on the vehicle.

“Lateral” means an axial direction.

“Lateral edges” means a line tangent to the axially outermost tread contact patch or footprint as measured under normal load and tire inflation, the lines being parallel to the equatorial centerplane.

“Net contact area” means the total area of ground contacting tread elements between the lateral edges around the entire circumference of the tread divided by the gross area of the entire tread between the lateral edges.

“Radial” and “radially” means directions radially toward or away from the axis of rotation of the tire.

### BRIEF DESCRIPTION OF THE DRAWINGS

The invention will be described by way of example and with reference to the accompanying drawings in which:

FIG. 1 is a front perspective view of a strip forming apparatus of the present invention;

FIG. 2 is a closeup view of the strip forming apparatus of FIG. 1 shown with only half of the application roller for clarity;

FIG. 3 is a front view of the applicator wheel of FIG. 2;

FIG. 4 is a front perspective view of the strip forming apparatus illustrating the path of the rubber.

FIGS. 5 and 6 are a side views of a second embodiment of a milltruder head and the application roller from different angles;

FIG. 7 is a bottom view of the milltruder head of FIG. 5.

### DETAILED DESCRIPTION OF THE INVENTION

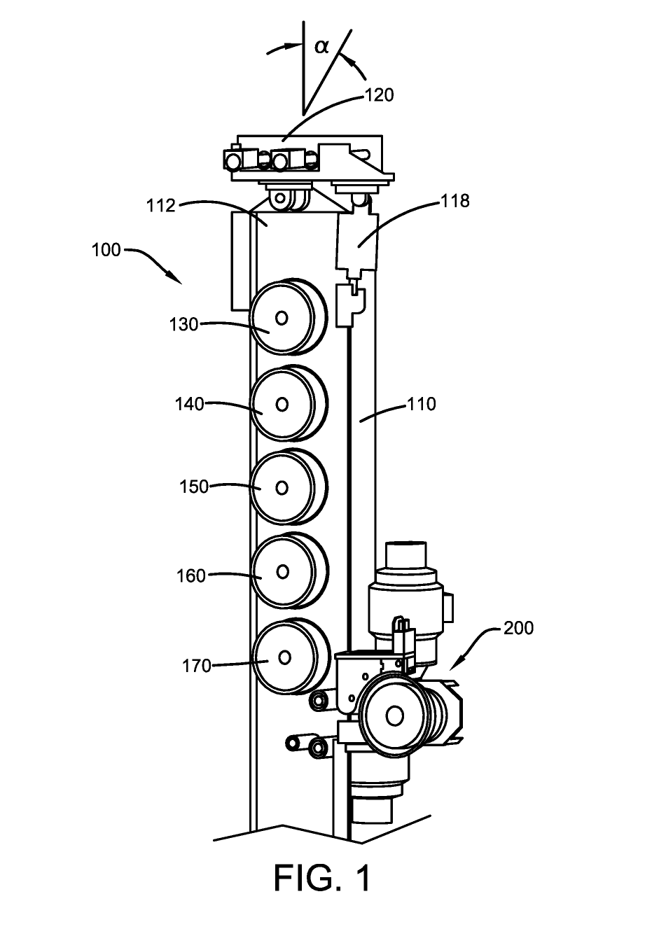

Referring to FIG. 1, a strip forming apparatus 100 is shown. The strip forming apparatus 100 includes a mounting frame 110 that is rectangular in shape, with a significantly longer vertical length than width. The mounting frame 110 has an upper end 112 that is pivotally mounted to a servomechanism 120. The servomechanism 120 functions to traverse the mounting frame forward and aft. The mounting frame 110 hangs vertically on the servomechanism allowing the stitching pressure to be adjusted by the traverse position. The angle α that the strip forming apparatus makes with the vertical direction may be adjusted by a servo mechanism 118. In order to adjust the stitching pressure, the angle α of the strip forming apparatus is varied. Variation of the angle changes the stitching pressure. Very low stitching pressure can be achieved which is required for small rubber strips. The stitching pressure can be adjusted by the traverse position of the strip forming apparatus in relation to a tire building drum, as described in more detail below.

As shown in FIG. 1, the mounting frame 110 has a length L and a width W, wherein the length L is aligned with the vertical direction. The length/width ratio is greater than 10. The mounting frame 110 has a plurality (at least two) of spaced apart preheat rollers 130, 140, 150, 160, 170 that are positionally fixed and rotatably mounted on the frame. The preheat rollers 130-170 are preferably aligned in the vertical direction so that the centers of each roller are preferably in a straight line. Each roller is spaced apart from an adjacent roller in the range of 1-5 inches. The rollers are not calendaring the rubber, as they are spaced apart. Calendering involves forming a shape between two rollers.

Each preheat roller has internal heaters (not shown). Preferably, each preheat roller is heated to a different temperature than the other preheat rollers. Preferably, the preheat rollers are progressively heated to a higher temperature so that the first preheat roller 130 is the coolest roller, while the second preheat roller 140 is heated to a higher temperature than the first preheat roller 130. The third preheat roller 150 is heated to a higher temperature than the second preheat roller 140, and the fourth preheat roller 160 is heated to a higher temperature than the third preheat roller 150. Likewise, the fifth preheat roller 170 is heated to a higher temperature than the fourth preheat roller 160. In summary, the preheat rollers are preferably maintained at progressively higher temperatures, increasing in temperature in the incremental range of about 5-20 degrees per roller with decreasing height of the mounting frame, so that the first or highest roller 130 is the coolest and the lowest roller is the hottest.

It is also preferred that the preheat rollers progressively increase in rotational speed from the highest vertical roller 130 to the lowest vertical roller 170, so that the lowest vertical roller 170 is the fastest.

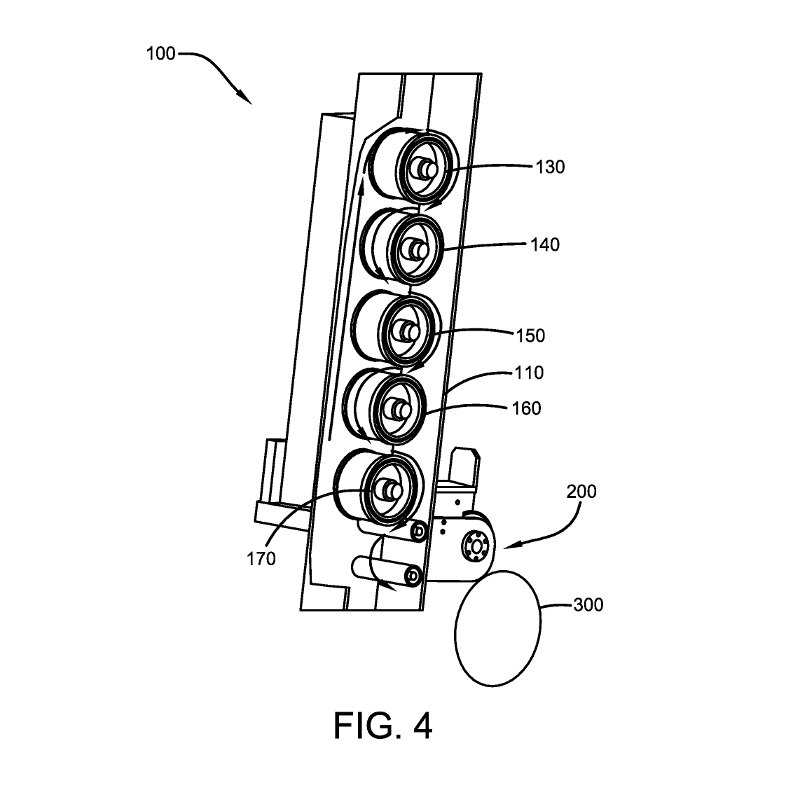

The rubber strip path is wound around the preheat rollers as shown in FIG. 4. As the rubber strip is wound around the preheat rollers, the increase in roller speed and temperature results in the strip being stretched and thinned to a strip having the desired width and thickness. In a first example, the series of vertically oriented preheat rollers process rubber stock having a 4-inch width, ¼ inch thickness into a 3-inch wide, ⅛-inch strip of rubber. However, the rubber stock could be any size. The strip formed from the strip forming apparatus may be as narrow as ⅛ inch and wider, and is not limited in size. Typically, the strips are in the range of 0.3 to 2 inches for tire building applications.

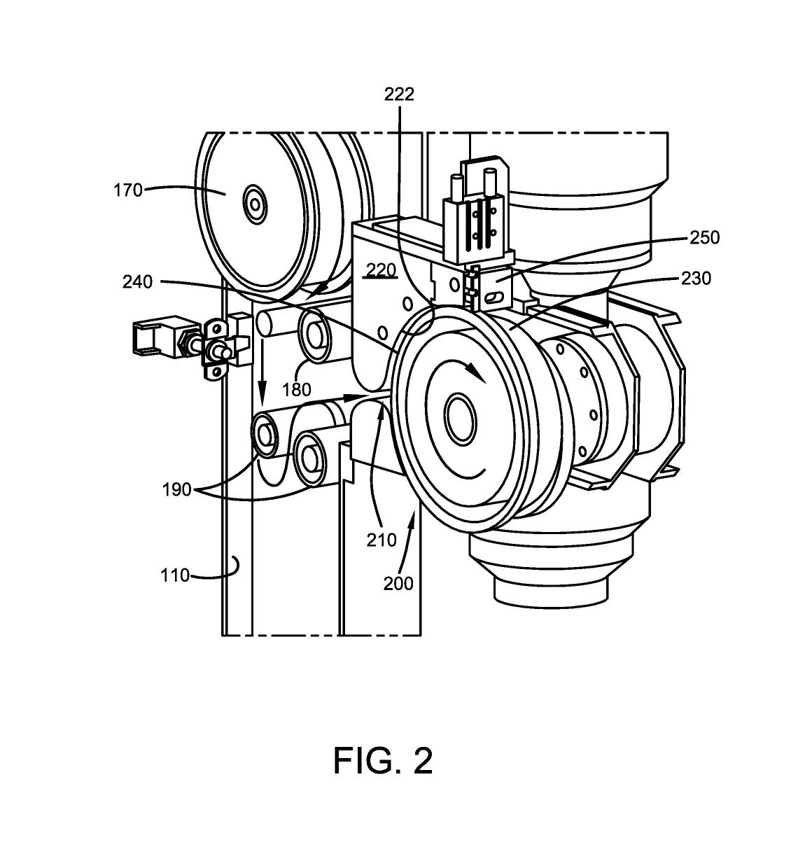

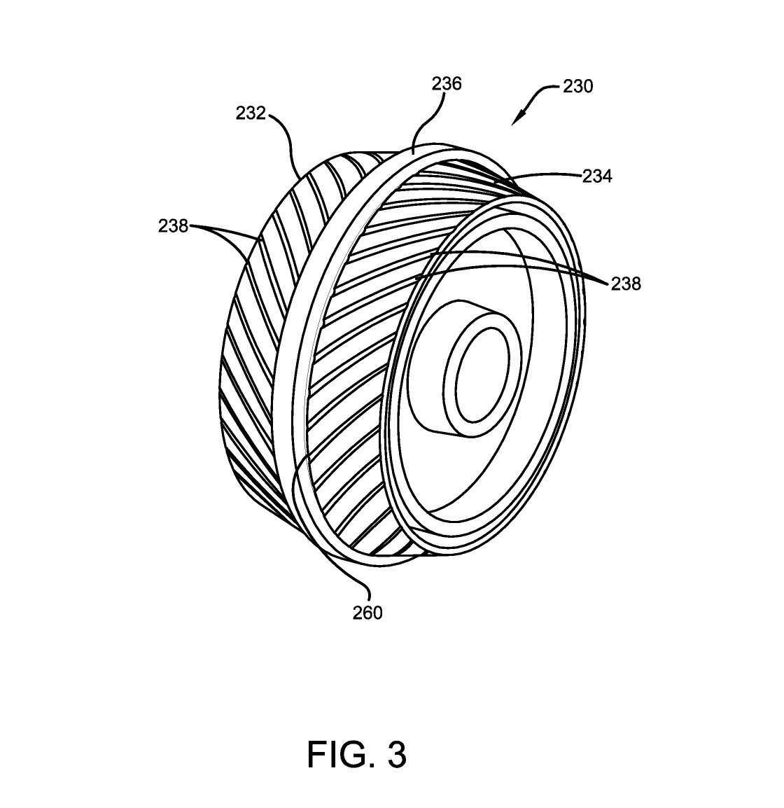

FIG. 2 illustrates the path of the rubber strip after exiting the series of vertically oriented preheat rollers 130-170. The rubber strip is fed into the opening 210 of a feedbox of a milltruder 200. The milltruder includes a milltruder head 220 and an application forming roller 230. A channel 240 is formed between the milltruder head 220 and the forming roller 230. FIG. 2 only illustrates half of the forming roller 230 for clarity, while FIG. 3 illustrates the entire forming roller 230. The channel 240 preferably decreases in area from the inlet to the outlet adjacent a die 250. The rubber is fed into the opening of the channel into engagement with the rotating forming roller and the lower end 222 of the head 220. Preferably, the milltruder head 220 is heated.

FIG. 3 illustrates the application forming roller 230. The application forming roller 230 is comprised of a first conical half 232 and a second conical half 234 separated by a central band 236. The conical halves 232,234 are arranged so that the largest diameter is adjacent the band 236, while the smallest diameter is axially outward of the band 236. The application roller 230 may additionally optionally comprise a plurality of grooves or serrations 238. The grooves or serrations 238 will increase pressure in die area which will increase output. The application roller 230 may optionally comprise a radial groove 260. The radial groove 260 is used to increase the quality of the edge of the strip. Once rubber fills the groove 260, it will flow the full 360 degrees back to the head. This action will pull any flash away from the rubber strip being applied to a tire building drum leading to a higher quality product.

As the application roller 230 rotates, it pulls rubber between the roller 230 and the milltruder head 220. As the rubber moves toward a die 250, the rubber is compressed and mixed both circumferentially and axially in the channel 240 between the milltruder head 220 and application forming roller 230. The axial mixing/movement is also increased due to the conical shape of the application roller. Since the outer diameter of the roller has a higher surface speed than the smaller diameter of the cone, rubber will tend to migrate to the surfaces with higher surface velocities, ie towards the band 236, generating additional mixing and pressure at the die opening. If more work or heat is required to process the rubber, the die 250 can be moved out to allow rubber to form a band around the application roller similar to a mill. This will allow multiple “passes” of rubber between milltruder head and roller, thus increasing work input.

The strip forming apparatus 100 may apply a strip of rubber onto a drum 300 or onto a carcass under construction. The application pressure may be adjusted by adjusting the angle α that the apparatus forms with the vertical direction.

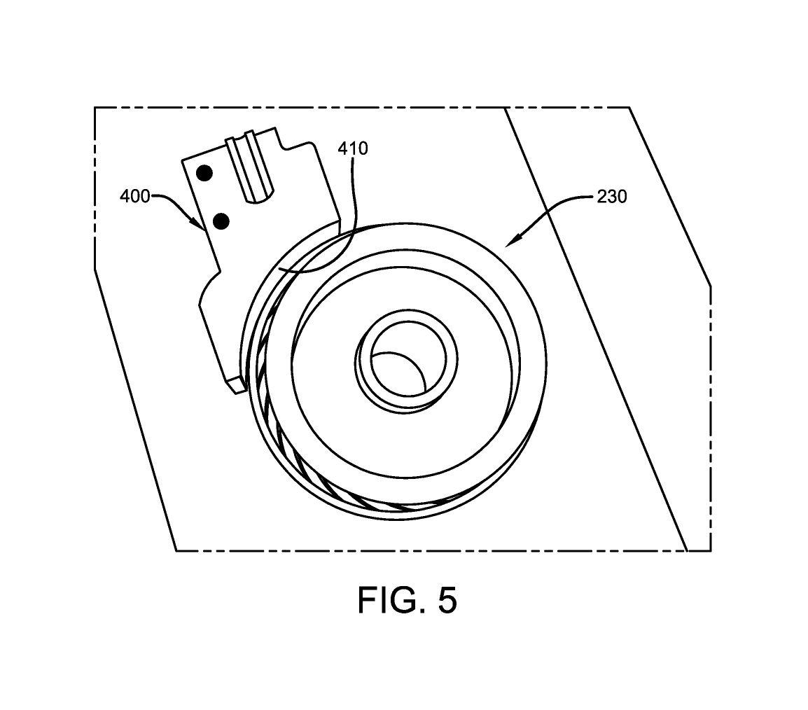

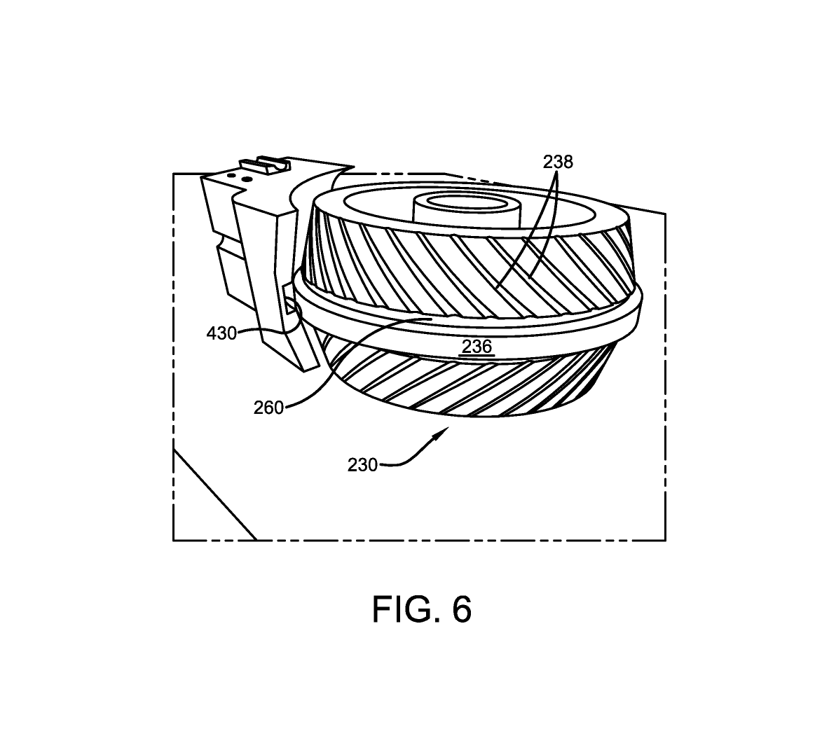

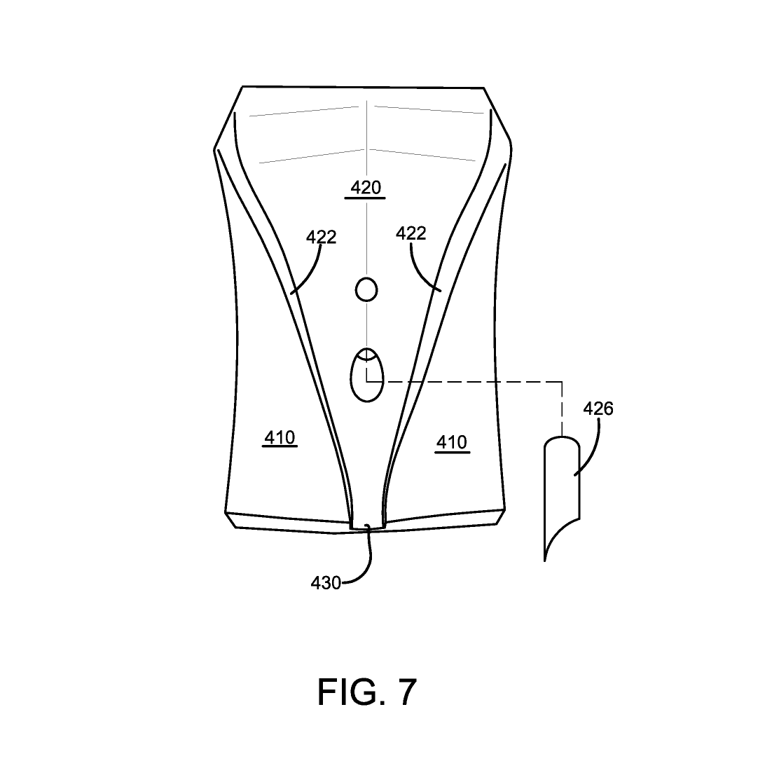

An alternate embodiment of a milltruder head 400 is shown in FIGS. 5-7. As shown in FIG. 7, the milltruder head 400 has a lower surface 410 having a curved surface. The lower surface 410 has a hole 424 for receiving a pin 426 therein. The pin 426 preferably has a beveled upper surface that protrudes from the lower surface 410 of the head. The pin functions to direct the flow of rubber towards a V shaped groove 420 located on the lower surface. The V shaped groove has a narrow portion of the V terminating in a die outlet 430. The die outlet 430 is positioned adjacent the band 236.

The advantages of the system are: Significant reductions in capital costs of a system vs extrusion. Significantly lower horsepower required (lower energy costs). Since the size of the system is small, multiple strips can be applied to the building drum simultaneously. This reduces capital cost and increases output because fewer drums and less conveying of building drums is required. Since the entire assembly is hanging vertically, stitching application pressures can be more easily achieved vs present extrusion technology. This leads to reduced trapped air and a higher quality product. Being able to control this stitching pressure also allows for reinforcement to be applied directly to the building drum without pre-calendering, further reducing complexity and costs.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. An apparatus for forming a strip of rubber, the apparatus comprising:
a support frame;
a first and second roller mounted on the support frame, wherein the first and second rollers are spaced apart from each other; and
an application roller located adjacent a milltruder head, and a channel formed in the space between the head and the outer surface of the application roller and the inner surface of the milltruder head; wherein said channel has an inlet and an outlet, wherein the inlet is located near the second roller, and the outlet is located adjacent a die.

2. The apparatus of claim 1 wherein a center of each roller is in vertical alignment.

3. The apparatus of claim 1 wherein the first and second rollers are spaced apart in the range of 1-5 inches.

4. The apparatus of claim 1 wherein the channel decreases in area from the inlet to the outlet.

5. The apparatus of claim 1 wherein the first and second rollers are heated.

6. The apparatus of claim 1 wherein the first and second rollers are heated at different temperatures.

7. The apparatus of claim 1 wherein the second roller rotates at a faster rpm than the first roller.

8. The apparatus of claim 1 wherein the second roller is heated to a higher temperature than the temperature of the first roller.

9. The apparatus of claim 1 wherein the application roller has a first conical side and a second conical side joined together by a band.

10. The apparatus of claim 1 wherein the milltruder head has a curved lower surface.

11. The apparatus of claim 10 wherein the lower surface of the milltruder head has a V shaped groove.

12. The apparatus of claim 10 wherein the lower surface of the milltruder head has a V shaped groove, wherein a narrow end of the V shaped groove terminates in a die.

13. The apparatus of claim 12 wherein the die is rectangular shaped.

14. The apparatus of claim 1 wherein the angle of the apparatus with the vertical axis is adjustable.

15. The apparatus of claim 1 wherein the rollers are aligned in the vertical direction.

16. A method of forming a rubber strip comprising the steps of
providing a support frame with a first and second roller mounted thereon, wherein the first and second rollers are spaced apart from each other; and
threading a rubber stock about the first and second roller, and then through a channel formed between a head and a rotating application roller, and then through an outlet die.

17. The method of claim 10 wherein the first roller rotates at a slower speed than the second roller.

18. The method of claim 10 wherein the first roller is heated to a lower temperature than the temperature of the second roller.
